(19) United States
(12) Patent Application Publication
(10) Pub. No.: US 2023/0023833 A1
(43) Pub. Date: Jan. 26, 2023

(54) ENFORCING CORRECT SEQUENCING OF FIRMWARE UPDATES

(71) Applicant: Dell Products L.P., Round Rock, TX (US)

(72) Inventors: Balasingh Ponraj SAMUEL, Round Rock, TX (US); Ricardo L. MARTINEZ, Leander, TX (US)

(73) Assignee: Dell Products L.P., Round Rock, TX (US)

(21) Appl. No.: 17/380,979

(22) Filed: Jul. 20, 2021

(51) Int. Cl. G06F 8/65; G06F 8/71

(52) U.S. Cl. CPC G06F 8/65; G06F 8/71

(57) ABSTRACT

A firmware update method maintains a firmware resource table for multiple firmware modules. The table includes a globally unique identifier (GUID) of the module and current version information. A firmware capsule is delivered to a capsule delivery service (CDS) and pushed to a platform. The capsule includes a firmware update and firmware dependency components, indicating GUIDs and minimum current versions of one or more other firmware modules that must be found in the resource table before installing the firmware module being processed. An update may be perform for the particular firmware module responsive to confirming the current version information satisfies the dependency criteria. If the version information does not satisfy the dependency criteria, the firmware capsule may be staged to a platform store and GUID in the resource table may be removed. Conversely, successfully processing a previously staged firmware capsule may include restoring or otherwise updating the GUID.

### TECHNICAL FIELD

The present disclosure relates to information handling system firmware and, more particularly, the management of information handling system firmware updates.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Historically, system firmware generally referred to as Basic Input/Output System (BIOS) has been delivered as one single capsule component from a firmware service maintained by the software platform provider. Two of the more recognizable firmware services includes Windows Update (WU) for Microsoft Windows platforms and Linux Vendor Firmware Service (LVFS) for Linux platforms.

More recently, the industry has been moving away from a unitary firmware paradigm in favor of multiple, compartmentalized BIOS update processes to support security and reliability best practices. Instead of one single monolithic firmware, system firmware is divided into multiple parts and some are directly delivered to the applicable firmware service by independent hardware vendors rather than the OEM or integrator.

### SUMMARY

In accordance with teachings disclosed herein, common problems associated with managing firmware updates are addressed by a method and system disclosed in the following description. In one aspect, a disclosed firmware update method, performed by a disclosed information handling system, maintains a firmware resource table for a plurality of firmware modules. The firmware resource table includes, for each of the firmware modules, a globally unique identifier (GUID) of the firmware module and current version information indicative of current version of the firmware module.

The method further includes receiving a firmware capsule from a firmware service, e.g., a Windows update (WU) service or a Linux vendor firmware service (LVFS). The firmware capsule includes a firmware update for a particular firmware module and dependency criteria indicative of prerequisite versions of other firmware modules. The dependency criteria may indicate GUIDs and minimum current versions of one or more other firmware modules that must be included in the firmware resource table as a prerequisite to installing the firmware module being processed.

The method further includes processing the firmware capsule based on the current version information and the prerequisite version information. Processing the firmware capsule includes performing an update for the particular firmware module responsive to confirming the current version information satisfies the dependency criteria. In various embodiments, the plurality of firmware modules may include all or some of the platforms system firmware modules, all or some of the platform's device firmware modules, all or some of the platform's UEFI drivers, or a combination thereof.

If the current version information does not satisfy the dependency criteria, processing the firmware payload may include staging the firmware capsule in a staging resource, without updating the particular firmware module. The staging resource may be a local nonvolatile storage resource, a network storage resource, or another suitable storage resource. Upon successfully updating a firmware component, any previously staged firmware capsules may be processed in the same manner. When a firmware capsule is staged, the applicable GUID may be removed from the firmware resource table. Conversely, successfully processing a previously staged firmware capsule may include restoring or otherwise updating the GUID and storing a success code in the firmware resource table for the applicable firmware module.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an information handling system suitable for implementing disclosed firmware module update features;

FIG. 2 illustrates dependency information suitable for use in conjunction with the system of FIG. 1, in accordance with disclosed subject matter;

FIG. 3 illustrates a first exemplary firmware module update scenario, in accordance with disclosed subject matter;

FIG. 4 illustrates a second exemplary firmware module update scenario, in accordance with disclosed subject matter;

FIG. 5 illustrates a third exemplary firmware module update scenario, in accordance with disclosed subject matter; and

FIGS. 6A and 6B illustrate a firmware update management method, in accordance with disclosed subject matter.

### DETAILED DESCRIPTION

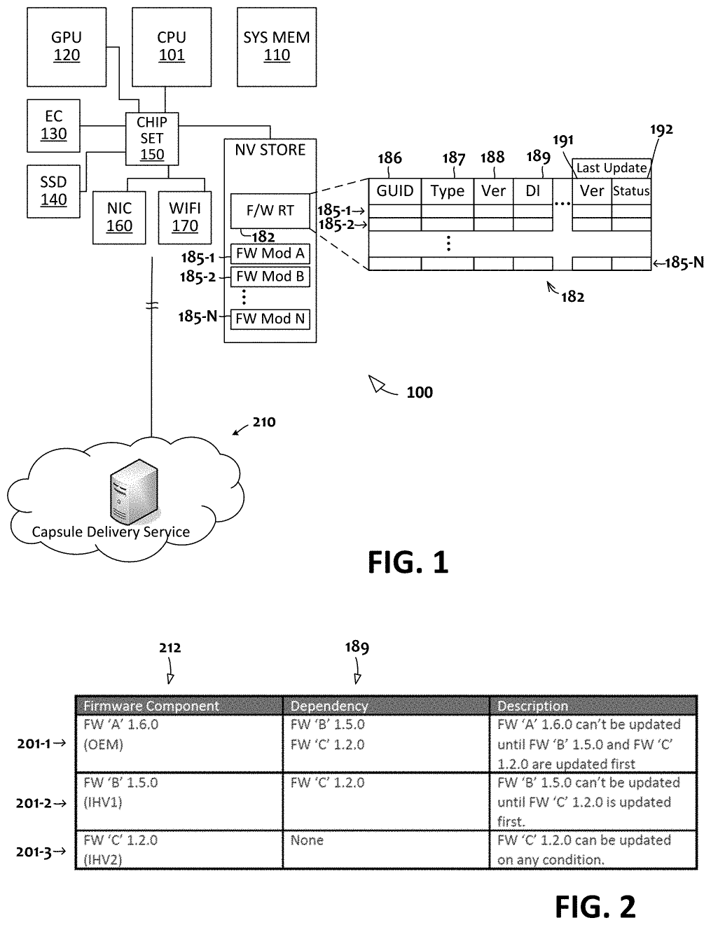

Exemplary embodiments and their advantages are best understood by reference to FIGS. 1-6B, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Turning now to the drawings, FIG. 1 is a block diagram illustration of an information handling system 100 in accordance with disclosed subject matter. The information handling system 100 illustrated in FIG. 1 includes a central processing unit (CPU) 101 coupled to a system memory 110 and a graphics processing unit (120). CPU 101 is further coupled to a chipset 150 configured to various peripheral devices and extension buses a communication path to CPU 101. The peripheral devices illustrated in FIG. 1 include an embedded control 130, a solid straight drive 140, a network interface card 160, and a Wi-Fi adapter 160. Chipset 150 is further couple to a non-volatile storage resource 180.

As depicted in FIG. 1, information handling system 100 is coupled to a cloud-based firmware update service referred to as capsule deliver service (CDS) 210, which receives firmware update capsules from OEMs and independent hardware vendors.

NV store 180 illustrated in FIG. 1 includes a firmware routing table 182 and a plurality of firmware modules 185-1 through 185-N corresponding to firmware module 181-1 through firmware module 181-N. Although FIG. 1 illustrates N firmware modules, the number of firmware modules may vary from among different implementations. In at least one embodiment, firmware modules 185 correspond to the system firmware modules for information handling system 100. In other environments, firmware modules 185 may include one or more device firmware modules, one or more UEFA drivers, or a combination thereof.

FIG. 1 illustrates additional detail of firmware resource table 182 in which the resource table includes a plurality of entries 181-1 through 181-N wherein each firmware table entry 181 includes various fields which correspond to columns as indicated in FIG. 1. The firmware table entries 181 of FIG. 1 include a GUID column 186, a firmware type column 187, a firmware version column 188, and a dependency information column 189, and a pair of last update fields including a last update version field 191, and a last update attempted status field 192. While FIG. 1 illustrates a particular configuration of firmware routing table including a particular combination of firmware table entry fields, other embodiments may include more, fewer, and or different fields than the firmware routing table 182 illustrated in FIG. 1. Similarly, the information handling system components illustrated in FIG. 1 are representative of components found in a wide variety of information handling system platforms. Additional and or different components, adapters, and other information handling resources may be employed by different platforms while still encompassing some or all of the firmware update management features disclosed hearing.

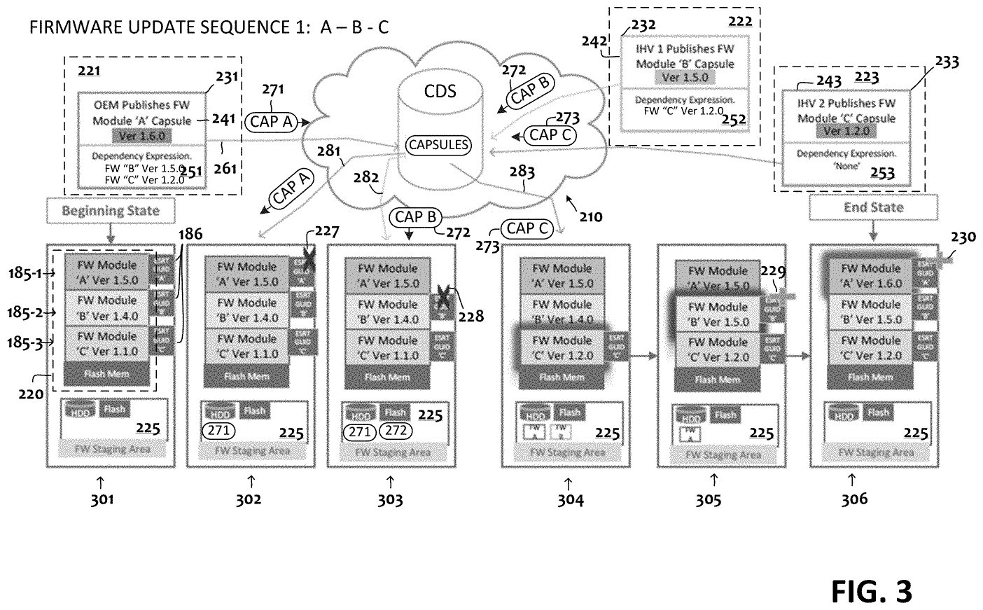

Turning now to FIG. 2, dependency information referenced in FIG. 1 is illustrated in additional detail. As depicted in FIG. 2, each firmware module 201 is associated with a current version 212 and dependency information 189, also referred to herein as dependency expression 189. The dependency information 189 illustrated in FIG. 1 indicates one or more firmware module Versions that must be present or identified in the firmware routing table before the applicable firmware component can be updated. Referring, as an illustration, to firmware module 201-1 corresponding to a firmware A module revision 1.6.0 which originated from the OEM, the illustrated dependency information 189 indicates firmware module A version 1.6.0 cannot be updated unless the platform has been updated to include version 1.5.0 of firmware module B and version 1.2.0 of firmware module C. Similarly, the dependency information 189 for firmware module be 201-2 indicates that firmware module B revision 1.5.0 cannot be updated unless the firmware resource table indicates that firmware module C has been updated to version 1.2.0. Lastly, the dependency information for firmware module C 201-3 indicates that the platform has firmware module C revision 1.2.0 and that there is no prerequisite regarding other firmware modules to update firmware module C, i.e., firmware module C can be updated at any time.

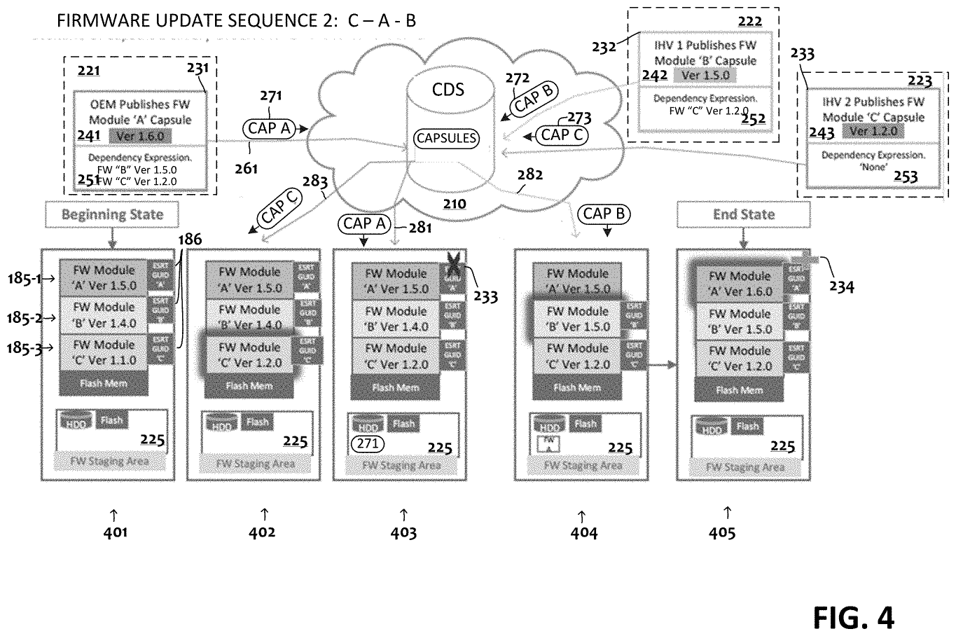

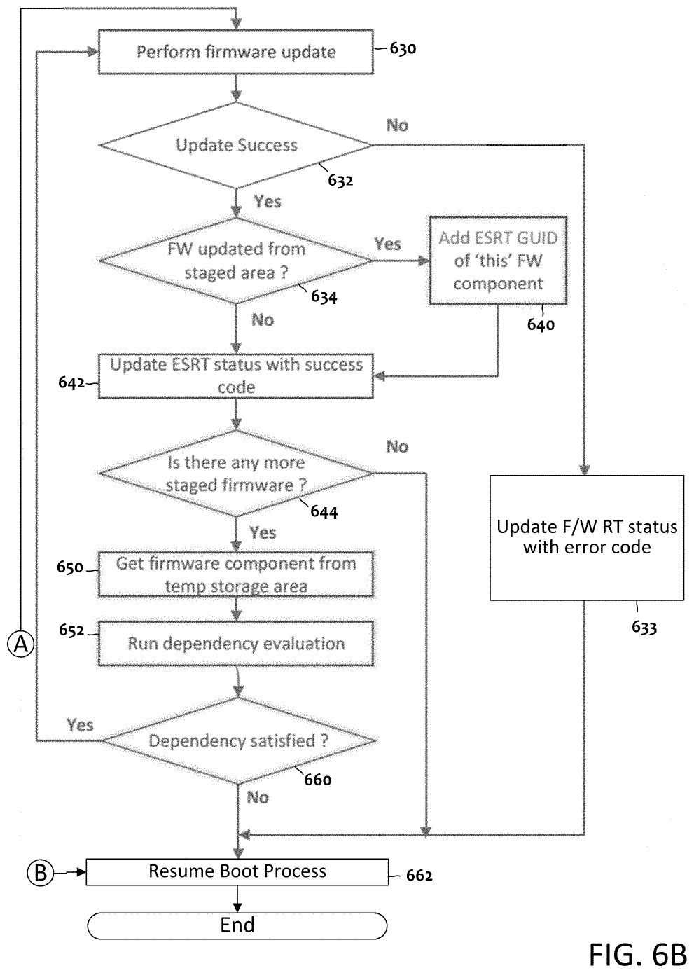

Before describing different firmware module update scenarios in FIG. 3 through FIG. 5, a firmware update management method is illustrated in FIGS. 6A and 6B as follows. The method 600 illustrated in FIG. 6 begins when a firmware capsule is received (operation 602) from a vendor of state services such as Windows update or LVFS. And integrity and security check is performed (Block step 604) in the capsule is extracted (operation 606). The illustrated method then retrieves (operation 610) a dependency payload from the capsule and then retrieves a firmware payload from the capsule (operation 612). Dependency evaluation is then performed (operation 614). The dependency evaluation, and at least some embodiments, is based upon information stored in the firmware resource table and dependency information included in the capsule. If the dependency mandated by the dependency information is satisfied method 600 branches to entry point A in FIG. 6B to be discussed below. If the dependency is not satisfied the firmware payload is then staged (operation 622) along with the dependency payload to a temporary location. In some embodiments, the temporary storage location may be a non-volatile storage resource on the platform itself or a network storage location. In addition to staging the firmware in step 622, the illustrated method 600 removes the GUID of the staged firmware component from the firmware resource table (operation 624) before branching to entry point B on FIG. 6B to be described below. From exit point B in FIG. 6A, method 600 simply resumes (operation 662) the standard boot process.

From exit point A in FIG. 6A, method 600 proceeds to perform the firmware updates (operation 630) and assess whether the update was successful (operation 632). If the update was unsuccessful, method 600 branches to step 633 where the method then updates the firmware resource table status field for the applicable firmware module with the appropriate error code associated with the failure. After updating the error code, the illustrated method terminates. If the update was determined in step 632 to be successful, the illustrated method 600 branches to step 634 where a determination is made regarding whether the firmware that was updated was from a staged area. If the updated firmware module was retrieved from the stage area, method 600 branches to step 640 where the firmware resource table GUID is added back. The illustrated method then updates (operation 642), the firmware resource table with a success code in the status field. A determination is then made (operation 644) of whether any more staged firmware is present. If not, the normal boot process is resumed at step 662 before the illustrated method terminates. If there are more staged firmware modules, method 600 branches to step 650 to retrieve one of the one or more staged firmware modules and run a new dependency evaluation (operation 652) before determining whether the dependency is satisfied in step 660. If the dependency was satisfied, process flow branches back to step 630 where the firmware update is performed. If, however, it is determined in step 660 that the dependency is still not satisfied for the steel-staged firmware module, method 600 branches to resume the boot process at step 662 before the method terminates.

Referring now to FIG. 3 through FIG. 5, three different firmware update cycle scenarios are presented to illustrate dependency-based firmware update management as disclosed herein. Each of the three scenarios illustrates a firmware update cycle as a series of system firmware states depicted in chronologic order from left to right, i.e., each system firmware state precedes the firmware state to its right. In each figure, the left-most state is a beginning system firmware state in which the platform includes three system firmware modules with specified revision levels and inter-dependencies. Specifically, the beginning state of system firmware 220 in each of the three figures, includes version 1.5.0 of firmware module A (185-1), developed and/or distributed by OEM 221, version 1.4.0 of firmware module B (185-2) from IHV1 222, and version 1.1.0 of firmware module C (185-3) from IHV2 223. In the each of the scenarios, an update is published for each of the three firmware modules, but the publication order, i.e., the chronological sequence in which the updates are published, differs among each of the three scenarios.

FIG. 3 illustrates a firmware update cycle for an A-B-C publication order in which the update for firmware module A precedes the update for firmware module B, which precedes the update for firmware module C. The state of system firmware 220 transitions from beginning state 301 to second state 302 following the publication 261 of update capsule A 271 by OEM 221 and the corresponding delivery 281 of capsule A from CDS 210 to the platform. Capsule A includes a module update component 241 and a dependency component 251. Upon receiving capsule A 271, the platform evaluates dependency component 251 to identify two dependencies. Specifically, dependent component 251 indicates that firmware module A 185-1 cannot be updated unless revision 1.5.0 of firmware module B 185-2 and revision 1.2.0 of firmware module C 185-3 are installed as part of system firmware 220. The platform can make this determination based, at least in part, on the GUID information 186 of the resident firmware resource table (not explicitly depicted in FIG. 3). After determining that the requisite firmware modules are not released within the platform's system firmware 220, capsule A 271 is staged in firmware staging area 225. Firmware staging area 225 may represent local hard disk storage, local flash memory storage, network storage, or some other suitable nonvolatile storage resource available to the platform. In addition to staging capsule 271, the platform removes (operation 227) the GUID 186 for firmware module A 185-1 from the resource table before resuming operation.

The platform transitions from state 302 to state 303 when IHV2 223 publishes capsule B 272 and CDS 210 pushes (operation 282) capsule B 272 to the platform. Capsule B 272 includes a dependency component 252 indicating revision 1.2.0 of firmware module C 185-3 as a prerequisite for updating firmware module B 185-2. The platform evaluates dependency component 252 for capsule B 272 and determines that the pre-requisite firmware is not resident on the platform. The platform then stages capsule B in the firmware steer staging area 225 and removes the GUID for firmware module B 185-2 from the firmware resource table.

Next, the platform transitions to state 304 when IHV2 223 publishes capsule C 273 and CDS 210 pushes (operation 283) capsule C to the platform. Because the dependency component 253 for capsule C 273 indicates no dependencies, the platform can install the firmware update 243 for firmware module C 1185-3 immediately and transition, as illustrated in FIG. 3 to state 304.

Recognizing that there are two capsules residing in staging area 225, the platform reevaluates the dependency component for each of the staged capsules. The dependency information for capsule A 271 is still not satisfied because firmware module B has not yet been updated to version 1.5.0. The dependency information 254 for capsule B 272, however, is now satisfied after the installation of version 1.2.0 of firmware module C 185-3. Accordingly, the platform transitions to state 305 by updating firmware module B 185-2 with module update 242 and storing (operation 228) a GUID for the updated firmware module B 185-2 to the firmware resource table.

After successfully updating firmware module B 185-2, the platform determines that capsule A 271 still resides in staging area 225. The platform then again evaluates the dependency component 251 of capsule A 271 and determines that the dependency criteria for capsule A 271 are met because firmware modules B and C have now been updated to the requisite firmware versions. The platform, therefore, updates firmware module A 185-1 with module update 241 and stores (operation 229) a GUID for the updated firmware module A 185-1 to the system firmware resource table, thereby arriving at state 306 and completing the firmware update cycle for the A-B-C update sequence.

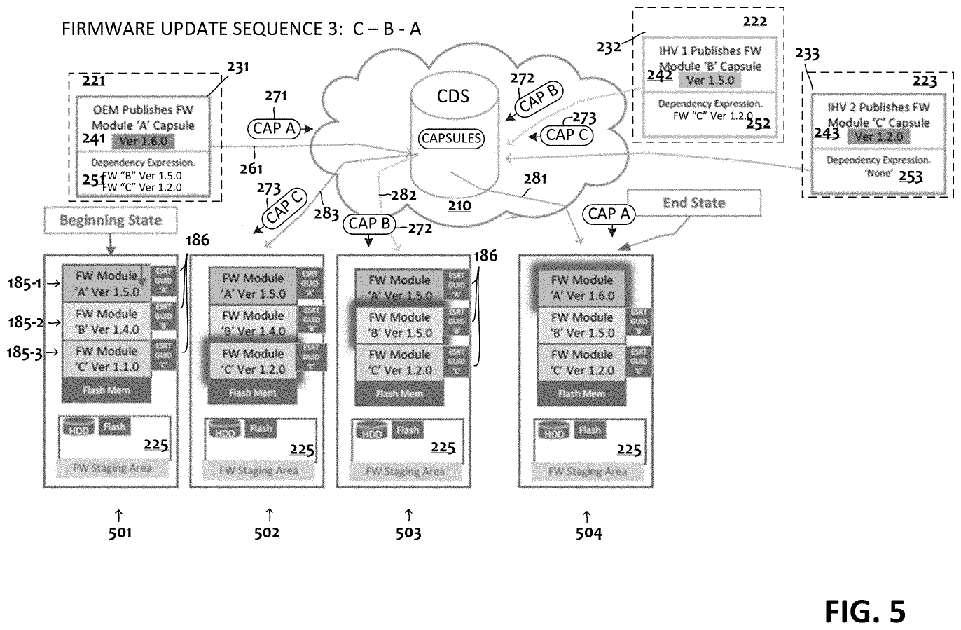

Referring now to FIG. 4, a firmware update cycle for a C-A-B update sequence is illustrated. In the scenario depicted in FIG. 4, Capsule C 273 is the first of the three update capsules pushed (operation 283) to the platform. Because the dependency component 253 of capsule C 273 indicates no dependencies, update component 243 is executed and the platform transitions to second state 402.

Next, capsule A 271 is pushed (operation 281) to the platform where the platform evaluates the corresponding dependency component 251 and determines that the dependencies are not met because firmware module B has not been updated to version 1.5.0. The platform therefore stages capsule A 271 in staging area 225 and removes (operation 233) the GUID for firmware module A 185-1 from the firmware resource table as illustrated in state 403. The platform next transitions to state 404 when IHV1 222 publishes capsule B 272 and pushes (operation 282) to the platform. The platform evaluates the dependency component 252 in capsule B 272 and determines that the dependency prerequisites are satisfied by the presence of firmware module C version 1.2.0. The platform then updates the system firmware to incorporate module B update 242. The platform then recognizes that capsule A 271 is staged in staging area 225 and evaluates the capsule's dependency component. Because firmware module B 185-2 and firmware module C 185-3 have been successfully updated to the requisite versions, the evaluation of dependency component 251 passes and the platform updates firmware module 185-1 with module update component 241. Upon successfully updating firmware module a 185-1, the system stores (operation 234) a GUID for firmware module 185-1 and transitions to the fully updated state 405. Those of ordinary skill will appreciate distinctions between the two scenarios illustrated in FIG. 3 and FIG. 4 and, in particular, the sequence in which update capsules are pushed to the influences the number of states the platform transitions through during the update cycle. Ultimately, however, regardless of the update sequence the system transitions from a beginning stage to a fully updated state without imposing any sequencing limitations on CDS 210, OEM 221 or the IHVs 222 and 223.

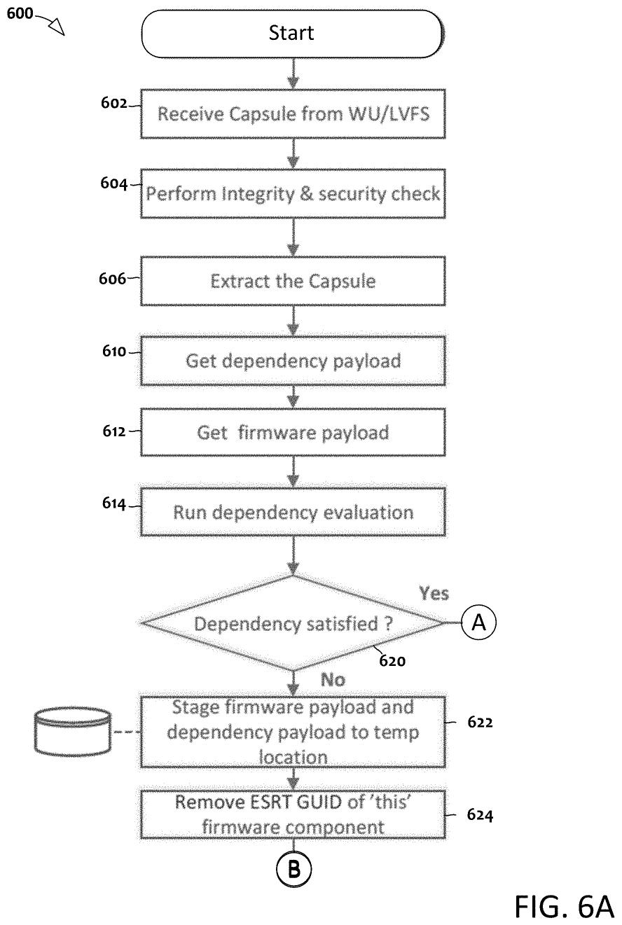

Referring finally to the update scenario illustrated in FIG. 5, a C-B-A update sequence is illustrated. In this scenario, because the module updates are pushed to the platform in a dependency-consistent order, whether intentionally or otherwise, the modules are updated without any staging of capsules and without any modification of the GUID information on the firmware resource table.

Specifically, while the platform is in the beginning state 501, the platform receives (operation 283) capsule C 273, confirms that the corresponding dependency information (no dependencies for firmware module C) is satisfied, and updates firmware module C 185-3 with the module update 243 as represented by second state 502. Next, the platform transitions to state 503 upon receiving (operation 282) capsule B 272 and confirming that the corresponding dependency information is satisfied before updating firmware module B 185-2 based on module update 242. Lastly, the platform receives (operation 281) capsule A 271 and confirms that the corresponding dependency information is satisfied, i.e., firmware module B version 1.5.0 and firmware module C version 1.2.0 are present. Upon confirming the dependency information is satisfied, the platform updates firmware module A 185-1 to complete the transition from beginning state 501 to end state 504. Those of ordinary skill will appreciate equivalency of each of the end states, 504 (FIG. 5), 405 (FIG. 4) and 306 (FIG. 3).

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A firmware update method, comprising:
maintaining a firmware resource table for a plurality of firmware modules wherein the firmware resource table includes, for each of the firmware modules, a globally unique identifier (GUID) of the firmware module and current version information indicative of current version of the firmware module;
receiving a firmware capsule from a firmware service, wherein the firmware capsule includes a firmware update for a particular firmware module and dependency criteria indicative of prerequisite versions of other firmware modules; and
processing the firmware capsule based on the current version information and the prerequisite version information, wherein processing the firmware capsule includes performing an update for the particular firmware module responsive to confirming the current version information satisfies the dependency criteria.

2. The method of claim 1, wherein the plurality of firmware modules comprise the system firmware modules for the platform.

3. The method of claim 1, wherein processing the firmware payload includes, responsive to determining that the current version information does not satisfy the dependency criteria, staging the firmware capsule in a staging resource without updating the particular firmware module.

4. The method of claim 3, wherein the staging resource comprises a local nonvolatile storage resource.

5. The method of claim 3, wherein the staging store comprises a network storage resource.

6. The method of claim 5, further comprising:
responsive to updating the firmware component, performing said processing on any previously staged firmware capsules.

7. The method of claim 6, wherein staging the firmware capsule includes removing the GUID from the firmware resource table and wherein processing the firmware capsule includes restoring the GUID to the firmware update resource table responsive to processing a staged firmware capsule and successfully updating the corresponding firmware module.

8. The method of claim 1, wherein the firmware service is selected from: a Windows update service and a Linux vendor firmware service (LVFS).

9. The method of claim 1, wherein the dependency criteria indicates GUIDs and minimum current versions of one or more other firmware modules that must be included in the firmware resource table.

10. The method of claim 1, wherein performing the firmware update includes storing a success or error code in the firmware resource table responsive to a successful or failed update.

11. An information handling system, comprising:
a central processing unit;
a system memory, communicatively coupled to the CPU, including process executable instructions that, when executed by the CPU, cause the information handling system to perform firmware update operations, wherein the firmware update operations include:
maintaining a firmware resource table for a plurality of firmware modules wherein the firmware resource table includes, for each of the firmware modules, a globally unique identifier (GUID) of the firmware module and current version information indicative of current version of the firmware module;
receiving a firmware capsule from a firmware service, wherein the firmware capsule includes a firmware update for a particular firmware module and dependency criteria indicative of prerequisite versions of other firmware modules; and
processing the firmware capsule based on the current version information and the prerequisite version information, wherein processing the firmware capsule includes performing an update for the particular firmware module responsive to confirming the current version information satisfies the dependency criteria.

12. The information handling system of claim 11, wherein the plurality of firmware modules comprise the system firmware modules for the platform.

13. The information handling system of claim 11, wherein processing the firmware payload includes, responsive to determining that the current version information does not satisfy the dependency criteria, staging the firmware capsule in a staging resource without updating the particular firmware module.

14. The information handling system of claim 13, wherein the staging resource comprises a local nonvolatile storage resource.

15. The information handling system of claim 13, wherein the staging store comprises a network storage resource.

16. The information handling system of claim 15, wherein the firmware update operations include:
responsive to updating the firmware component, performing said processing on any previously staged firmware capsules.

17. The information handling system of claim 16, wherein staging the firmware capsule includes removing the GUID from the firmware resource table and wherein processing the firmware capsule includes restoring the GUID to the firmware update resource table responsive to processing a staged firmware capsule and successfully updating the corresponding firmware module.

18. The information handling system of claim 11, wherein the firmware service is selected from: a Windows update service and a Linux vendor firmware service (LVFS).

19. The information handling system of claim 11, wherein the dependency criteria indicates GUIDs and minimum current versions of one or more other firmware modules that must be included in the firmware resource table.

20. The information handling system of claim 11, wherein performing the firmware update includes storing a success or error code in the firmware resource table responsive to a successful or failed update.
